(19) United States
(12) Patent Application Publication
(10) Pub. No.: US 2003/0195951 A1
(43) Pub. Date: Oct. 16, 2003

(54) Method and system to dynamically detect, download and install drivers from an online service

(76) Inventors: Walter I. Wittel JR., Redmond, WA (US); Sunil Pai, Redmond, WA (US); Joseph Ghartey Dadzie, Redmond, WA (US); Thomas A. Sponheim, Seattle, WA (US)

Correspondence Address: Ladi O. Shogbamimu, SHOOK, HARDY & BACON L.L.P., 1200 Main Street, Kansas City, MO, 64105-2118, US

(21) Appl. No.: 10/121,895

(22) Filed: Apr. 12, 2002

(51) Int. Cl. G06F 15/16

(52) U.S. Cl. 709/220; 717/176

(57) ABSTRACT

The present invention is directed to a system and method for dynamically detecting, downloading and installing drivers on a client system. The present invention operates in a client/server architecture of a network environment. In operation, information relating to a client system is provided to a server, and that information is used to match available driver information located on the server to the received client system information.

### STATEMENT REGARDING FEDERALLY-SPONSORED RESEARCH OR DEVELOPMENT

None.

### CROSS-REFERENCE TO RELATED APPLICATIONS

None.

### TECHNICAL FIELD

The present invention relates to computer software. More particularly, the invention relates to a system and method for detecting, downloading and installing drivers on a client system from a server.

### BACKGROUND OF THE INVENTION

Computing systems today include a plethora of hardware and software components that originate from a wide variety of manufactures. The need for efficient and consistent collaboration between these various components is essential to the success and usefulness of these computing systems. An operating system of a computing system provides the interface between user application programs and underlying hardware or software components of the system. Communications between the operating system and individual manufacture's components are usually facilitated by customized software programs that function as a translator and are typically referred to as drivers. A driver provides an interface between proprietary manufacturer components and the operating system.

The constant evolution of the computing industry and advancements in technology result in changes to operating environments, operating systems, hardware devices and software components. The nature of these changes often necessitate a corresponding change or more appropriately an upgrade to the associated drivers that provide the interface between the new and the legacy technologies.

Drivers are built by teams of people at the operating system's manufacturer as well as by independent vendors and other third parties. By way of example only, an operating system such as WINDOWS brand operating system from Microsoft in Redmond, Wash. includes a number of hardware device drivers when sold. However, the vast majority of these drivers are actually released after the release of the operating system. In other words, the version of the driver that ships with the operating system is probably not the most recent version. Vendor fixes of defects also need to be delivered to the client. The delivery of the latest driver versions to client systems pose some significant challenges. This difficulty is further compounded by the fact that new hardware products that are added to the client computing system require drivers to be located and installed. Even further, the difficulty increases when faced with the fact that there are numerous drivers to support the vast array of available hardware products. For example, for one particular model of a hardware device such as a network interface card (NIC), the manufacturer could have various versions of the driver, each version directed to address different combinations of the NIC and the operating system. The same model of NIC could also have drivers that were developed by other third party vendors. In other words, there are multiple drivers and multiple sources for drivers that confront a user.

Traditionally, with the upgrade of the operating system, the addition of hardware devices or addition of software components, it is usually desirable for the operating system to dynamically support new hardware and improve functionality of device drivers with minimal impact on the user. Support for the associated improvements thus far has been handled by the use of device/component manufacturer supplied drivers on floppy disks or other media. The supplied drivers typically offer no automated guidance to the user on which particular driver or driver version should be utilized, thus leading to poor user experiences.

In an attempt to remedy this situation, a solution was provided wherein catalogs of drivers were downloaded from a file share. The catalogs were then used to determine which driver(s) to download and install on a client system. This solution presented significant scalability problems because of the need to download large catalogs to the client machine. Catalogs contained redundant and unnecessary data because they included everything for the operating system or the manufacture and were not tailored to the client device. In addition, testing of the applicability of the drivers to the client system had to be performed on the client for each of the cataloged drivers. Furthermore, the catalog solution was also limited by how quickly one could add or remove existing drivers from the file share because of the reliance of the solution on pre-compiled catalogs, which had to be regenerated each time a driver was added or removed.

In addition to the problems discussed above, existing systems and drivers required proprietary and processor dependent data structures to compress and limit the potentially huge amounts of data that are needed to down load a complete driver catalog to the client from a server. A method of hashing hardware identifications and downloading large bit masks to a client system was utilized for matching drivers that were resident on a server. The hash method involved setting a bit, which in combination with the operating system version and other client system information, was then used to construct paths to a “bucket” file containing actual information on a potential driver match. The client system then downloads the bucket, searches for the record in the proprietary data and determines if the driver in the bucket is better than the driver installed on the client. In the event that the driver is better, the URL is obtained from the bucket data and used to download the driver. On the server side of things, the backend, all available drivers must have their ID's hashed and used to build “bucket” files based on the hash. This process must be completed for all supported operating systems and locales, resulting in large quantities of redundant data on the server. The buckets and available drivers must be reflected in the hash bitmap, thus requiring a build and propagation of all catalog files on the server when drivers are added. This greatly complicates the build process and lengthens the time required to get a new driver posted on a server. In addition, any attempts to modify driver matching algorithms require a rebuild and redistribution of client side software control objects. Since the client side controls must be in synchronization with the server catalog data, the change to all clients must occur virtually simultaneously or require other logic and data to cope with unsynchronized clients.

In light of the foregoing, there exists a need to provide a system and method that will enable the automated detection of available drivers without the need for static server based catalogs, allow the rebuild and propagation of more efficient drivers, and enable the implementation of improved detection algorithms on a server without the need to update client software. In other words, there exists a need for a loosely coupled client/server architecture to provide dynamic, online support for driver detection and installation.

### SUMMARY OF THE INVENTION

The present invention is directed to a method and system for use on a computer to provide updated drivers using a client/server architecture. A specification of installed devices on a client computing device is obtained and then packaged in a data structure that is recognizable to an update server. The data structure is transmitted from the client computing device to an update server; which receives the information and matches the specifications of the installed client devices and compatible devices to an index of current drivers that have been reported to the update server. Utilizing this information, the server then provides a catalog of drivers to the client computing device, wherein the catalog contains entries of driver locations for the client devices these locations existing on one or more content servers.

Additional aspects of the invention, together with the advantages and novel features appurtenant thereto, will be set forth in part in the description which follows, and in part will become apparent to those skilled in the art upon examination of the following, or may be learned from the practice of the invention. The objects and advantages of the invention may be realized and attained by means, instrumentalities and combinations particularly pointed out in the appended claims.

### BRIEF DESCRIPTION OF THE SEVERAL VIEWS OF THE DRAWING

The present invention is described in detail below with reference to the attached drawings figures, wherein:

FIG. 1 is a block diagram of a computing system environment suitable for use in implementing the present invention;

FIG. 2 is a schematic diagram, illustrating an architecture of the present invention along with component communications;

FIG. 3 is a flow diagram illustrating the prior art method for making drivers available to a user;

FIG. 4 is a flow diagram illustrating particular steps of the client side process in the present invention;

FIG. 5 is a flow diagram illustrating particular steps of the server side process of the present invention;

FIG. 6 is an illustration of interaction between several exemplary applications and the present invention;

FIG. 7A is a flow diagram of a scenario for dynamic updating in a utility component of WINDOWS operating system;

FIG. 7B is a flow diagram of a scenario for a site driver check in the utility program of FIG. 7A;

FIG. 8A is a flow diagram of an exemplary scenario for the hot plug in application of FIG. 6;

FIG. 8B is a flow diagram of a scenario for updating a driver within a device manager utility program;

FIG. 9 is a flow diagram of a plug and play hardware installation scenario;

FIG. 10 is a flow diagram for WINDOWS Automatic Update component.

### DETAILED DESCRIPTION OF THE INVENTION

The present invention is directed to a system and method for detecting, downloading and installing drivers on a client system from an online service, while also allowing the aggregation of drivers from multiple manufacturers and vendors on a single site. The system of the present invention incorporates a client/server infrastructure that allows dynamic and automatic support of client system devices. According to the method of the present invention, a client system provides a specification of its environment, including installed devices, drivers and other system information. This system specification conforms to a recognizable data structure, such as an XML based schema. Within the data structure there is for example, a device element corresponding to each plug-and-play (PnP) device, such as a modem. PnP is a methodology that facilitates the recognition and identification of a hardware device that is plugged into a system, so as to facilitate automatic installation and configuration of the device within the operating system. Next, the data structure is packaged for transmission to a server. In an embodiment of the present invention, the packaging and transmission is performed utilizing Simple Object Access Protocol (SOAP) industry standards. By definition of the World Wide Web Consortium (W3C), SOAP is a light weight protocol for the exchange of information in a decentralized, distributed environment. It is a protocol that is based on XML and consists of: (1) an envelope that defines a framework for describing what is in a message and how to process it, (2) a set of encoding rules for expressing instances of application-defined data types, and (3) a convention for representing remote procedure calls and responses.

The server utilizes the received information to identify and ascertain the need for newer or more specific drivers and sends a response back to the client. In one embodiment of the present invention, the server response is in the form of meta-data or a catalog of locations where identified drivers can be downloaded. In another embodiment, the server response is the meta-data for a single matching driver for requested device.

It would be understood by those skilled in the art that while the present invention is described with reference to a client and server, the system and method of the present invention is applicable to communications between any two or more computing environments, and such communication should be considered within the scope of the present invention. In particular, the present invention is also applicable to mobile and wireless devices where traditional driver delivery mechanisms to support new or updated drivers is cumbersome. The particular embodiments described herein are intended in all respects to be illustrative rather than restrictive. Alternative embodiments will become apparent to those skilled in the art to which the present invention pertains without departing from its scope.

Having briefly described an embodiment of the present invention, an exemplary operating environment for the present invention is described below.

Exemplary Operating Environment

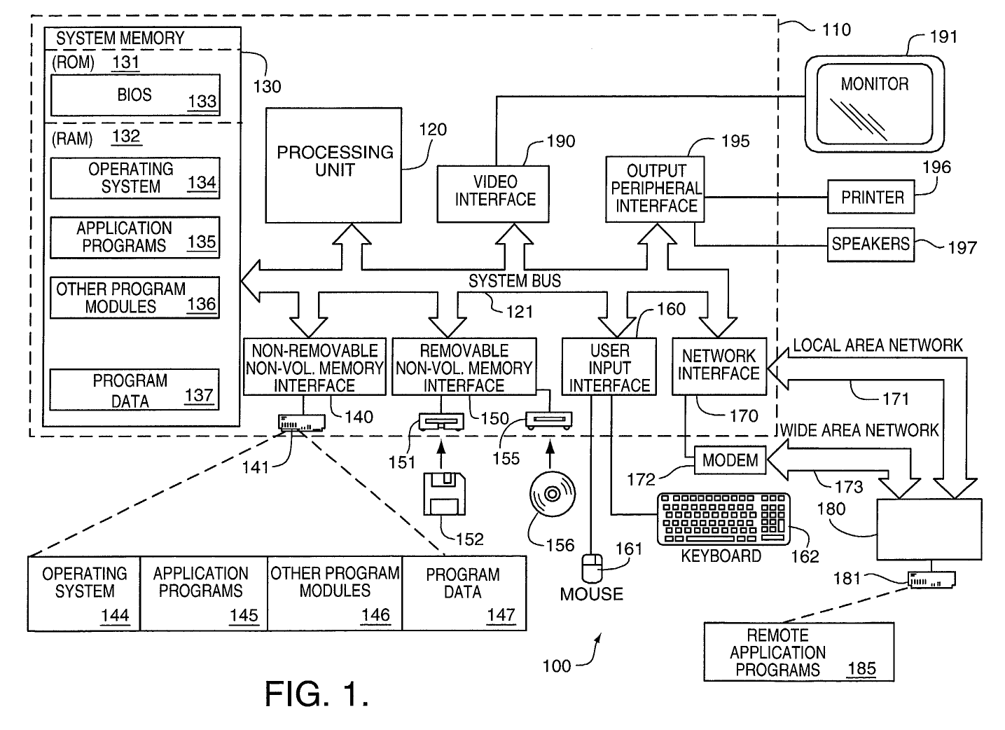

Referring to the drawings in general and initially to FIG. 1 in particular, wherein like reference numerals identify like components in the various figures, an exemplary operating environment for implementing the present invention is shown and designated generally as operating environment 100. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention may be described in the general context of computer-executable instructions, such as program modules, being executed by a computer. Generally, program modules include routines, programs, objects, components, data structures, etc. that perform particular tasks or implement particular abstract data types. Moreover, those skilled in the art will appreciate that the invention may be practiced with a variety of computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system 100 for implementing the invention includes a general purpose computing device in the form of a computer 110 including a processing unit 120, a system memory 130, and a system bus 121 that couples various system components including the system memory to the processing unit 120.

Computer 110 typically includes a variety of computer readable media. By way of example, and not limitation, computer readable media may comprise computer storage media and communication media. Examples of computer storage media include, but are not limited to, RAM, ROM, electronically erasable programmable read-only memory (EEPROM), flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during startup, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/nonremovable, volatile/nonvolatile computer storage media. By way of example only, FIG. 1 illustrates a hard disk drive 141 that reads from or writes to nonremovable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/nonremovable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through an non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Typically, the operating system, application programs and the like that are stored in RAM are portions of the corresponding systems, programs, or data read from hard disk drive 141, the portions varying in size and scope depending on the functions desired. operating system 144, application programs 145, other program modules 146, and program data 147 are given different numbers here to illustrate that, at a minimum, they are different copies. A user may enter commands and information into the computer 110 through input devices such as a keyboard 162 and pointing device 161, commonly referred to as a mouse, trackball or touch pad. Other input devices (not shown) may include a microphone, joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through a output peripheral interface 195.

The computer 110 in the present invention will operate in a networked environment using logical connections to one or more remote computers, such as a remote computer 180. The remote computer 180 may be a personal computer, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

Although many other internal components of the computer 110 are not shown, those of ordinary skill in the art will appreciate that such components and the interconnection are well known. Accordingly, additional details concerning the internal construction of the computer 110 need not be disclosed in connection with the present invention.

When the computer 110 is turned on or reset, the BIOS 133, which is stored in the ROM 131 instructs the processing unit 120 to load the operating system, or necessary portion thereof, from the hard disk drive 140 into the RAM 132. Once the copied portion of the operating system, designated as operating system 144, is loaded in RAM 132, the processing unit 120 executes the operating system code and causes the visual elements associated with the user interface of the operating system 134 to be displayed on the monitor 191. Typically, when an application program 145 is opened by a user, the program code and relevant data are read from the hard disk drive 141 and the necessary portions are copied into RAM 132, the copied portion represented herein by reference numeral 135.

System and Method for Dynamically Detecting, Downloading and Installing Drivers

The present invention is directed to a system and method for dynamically detecting, downloading and installing drivers for a client system by describing information relating to the client system, which then is transferred to a server system for the purpose of matching available information on the server to the client system's components. The transfer of information will be discussed in the context of a transfer from a client system to a server system or other online service on a network such as the internet. The information description of the present invention involves the creation of an XML file. The XML file contains tags that describe the environment and specifications of the client system, as well as tags that provide other types of information including, but not limited to, things such as device identification, compatible devices, language, versions of existing drivers, and other system characteristics. The XML file can also contain meta-data, which is extraneous information that a developer seeks to pass between systems. Finally, the XML file facilitates the retrieval of information. As would be understood by those skilled in the art, other forms of structuring data besides XML can be used to provide the functions described herein and are considered within the scope of the present invention. The present invention will also be discussed with reference to some particular application programs that can be found in MICROSOFT's WINDOWS Operating Environment. As would be understood by those skilled in the art, such references are provided for clarification in the understanding of the present invention and should not in anyway be considered as limiting the invention to this or any other operating environment standard or application programs.

The present invention may be described in the general context of computer-executable instructions such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

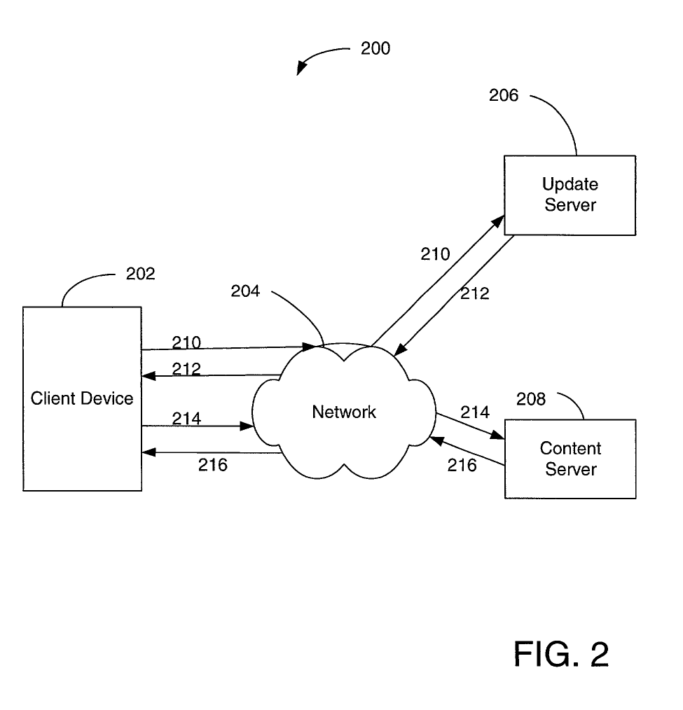

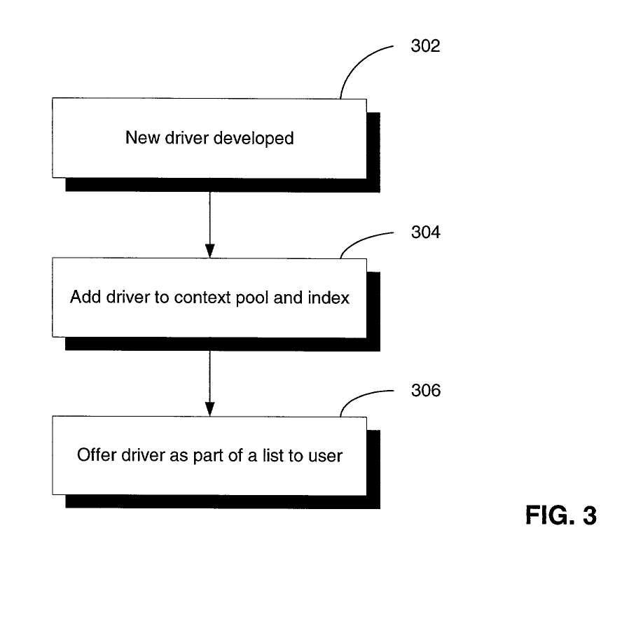

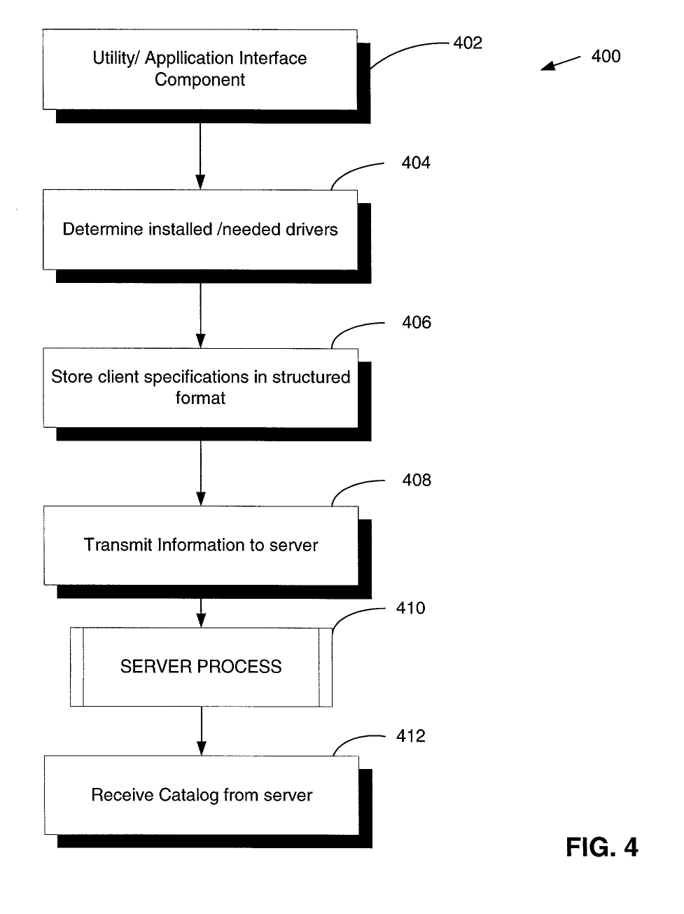

An embodiment of the present invention will be described with reference to FIG. 2, which provides a schematic diagram illustrating an architecture and components for implementing the present invention. To aide in understanding the present invention, the historical method for making drivers available to client systems will be briefly discussed with reference to FIG. 3. This will be followed by more detailed discussions referring to FIGS. 4 through 11 on particular steps and events that occur in conjunction with the component communications of FIG. 2.

Referring initially to FIG. 2, a client server network architecture 200 is shown. The architecture as shown comprises a client computing device 202, a network 204, an update server 206 and a content server 208. Also shown are steps of communications by and between each of the network devices, which are represented by the arrows 210 through 216 and wherein the direction of communication is indicated by the direction of the arrow. Arrows with the same numbers indicate the source and destination of a communication. As would be understood in the art, client device 202 and the servers 204,206 can include any one or number of hand held units, wireless device mobile units, computers or other computing devices. Generally, client device 202, update server 206, and content server 208 are connected via a suitable communication medium to network 204.

An event on the client device 202 such as, the detection of new hardware, a request from an application program or a user's input, results in system specifications of the client device 202 being sent to the update server 206. The system specifications are sent in communication step 210 via the network 204. Update server 206 utilizes the received system specifications to detect any suitable drivers or updates thereto and returns a catalog to the client 202 in step 212. A catalog is a collection of meta-data relating to a driver along with other information that would be useful to the client system. The driver meta-data provides information on the driver such as a file date, version number, a location for the driver files, size of the files and so on. In essence, everything about the driver is provided other than the driver files. Based on the catalog, client 202 is then able to obtain the location for particular drivers such as a Uniform Resource Locator (URL). Typically, such a location will be a file share server such as content server 208, from which the client can then request files or data pertaining to the particular driver. This request occurs in step 214. In response to the request, the driver information is downloaded to the client device 202 in step 202. The driver can then be newly installed or updated on the client device 202.

Turning to FIG. 3, a flow diagram of one prior art method for locating drivers or driver updates is shown. First of all it is noteworthy that the process does not involve any communications or interactions between client systems and the server or other repository for new drivers. As shown, a new driver or update is first created by some manufacturer or vendor at step 302. At best, that driver is added to a content pool and indexed at step 304. This addition and indexing typically occurs on a server or site of the operating system manufacturer or other service provider or in some instances, on a third party driver developer's site. From the server or site, the driver is offered to users who are able to locate the context pool, at step 306. This means that first the user must somehow become aware of the existence of the new driver or updates. The user must then determine which driver they need for their particular environment—operating system version, device model, and so on. Next, the user has to determine which version to retrieve, how to efficiently obtain the information and finally how to implement or install the new driver. The mode of connection to the site, modem, wireless, high speed connection or other means then dictates bandwidth and impacts the amount of time that will be required to investigate a site and ultimately locate and download the information. Further still, a user is also typically faced with having to visit multiple vendor sites or locations for the variety devices that exist on their system.

The present invention addresses these and other issues by the implementation of a client/server architecture that incorporates intelligent processes on both the client and server side. These processes will be discussed individually and then collectively by way of discussions of some sample scenarios. Turning to FIG. 4, the steps of the client side of an embodiment of the present invention are illustrated and generally referenced as 400. Initially, a component that provides the interaction to other client system utilities and applications, is triggered to initiate the client process, at step 402. As will be discussed later, client utilities and applications that interact with the present invention (parent applications/utilities) include but are not limited to such things as PnP, Device Manager, AutoUpdate, and user interfaces. These utilities will be discussed in the sample scenarios later in this document.

At step 404, a determination of the drivers that are currently installed on the client system as well as the drivers that will be needed is made. This determination is particularly required when a new device has been recently added to the system. However, this only occurs if the calling or initiating parent utility/application does not provide hardware device and compatible identifications, to the client process of the present invention. When identifications are provided, they are provided according to a recognizable data structure. In which case, the client process can skip on to step 406. Otherwise when the installed/needed drivers determination must be made, an embodiment of the present invention utilizes a detection algorithm. For example, such an algorithm implements the GetSystemSpec Application Program Interface (API) in the WINDOWS operating system. GetSystemSpec obtains client system information (installed devices, installed drivers, and so on) and generates a system specification conforming to a recognizable data structure. In either the case where identifications are provided or where detection is implemented, the generated specification conforms to a structure such as an XML schema-SystemInfoSchema.XML. Within the schema, is a description of the operating system, spoken language, BIOS information, a list of hardware devices and compatible identifications for all PnP devices, driver versions or dates and so on. In the situation of a PnP initiated detection, device elements corresponding to the PnP device would be enumerated within the schema. In other words, hardware and compatible identifications are gathered only for the single PnP device indicated by the action of hot-plugging the device or through interaction with the user via a user interface. The schema or other document format for holding the system information is generated at step 406.

Next, the schema information is appropriately packaged for transmission to a server. In the currently described exemplary embodiment of the present invention, the information is packaged and sent using the industry standard SOAP, at step 408.

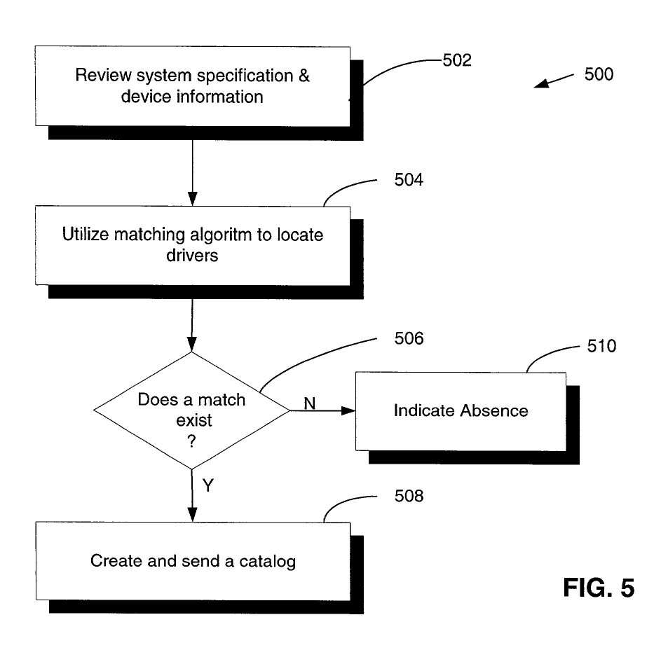

At step 410, a server process, which will be discussed in detail with reference to FIG. 5, utilizes the packaged schema information and returns some meta-data in the form of a catalog of information to the client at step 412. As previously discussed, depending on the particular client utility or application (i.e. the parent), that is interacting with the present invention, step 412 could entail the return of the meta-data for specific matching driver(s).

Based on the received meta-data of step 412, the client system parent utility or application is then able to obtain and/or install the appropriate driver(s). It should be noted that the catalog of information could also be utilized by a client side application or utility to display information to a user. The displayed information could be the offer to download or install one or more drivers that are described in the received catalog.

As previously mentioned, there is a server process component to the present invention. FIG. 5, illustrates the steps of the server side process, which are identified as 500. The server process receives specifications in a structured format from a client system. Utilizing the information contained therein, at step 502, there is a review of the system specification and devices to correctly correlate device identifications with installed or needed drivers and so on. Following this, a matching optimization algorithm is utilized by the server process to examine it's database of drivers in order to find appropriate drivers for the client at step 504. If a match is found at step 506, the server process builds a catalog of information for download to the client, at step 508. On the other hand, if an appropriate driver is not found, or if the client already has the most current and applicable driver, an appropriate indication of the condition is made in the catalog and passed on to the client at step 510. As discussed above, the client system then may utilize the information in a manner that is consistent with the parent client application or utility.

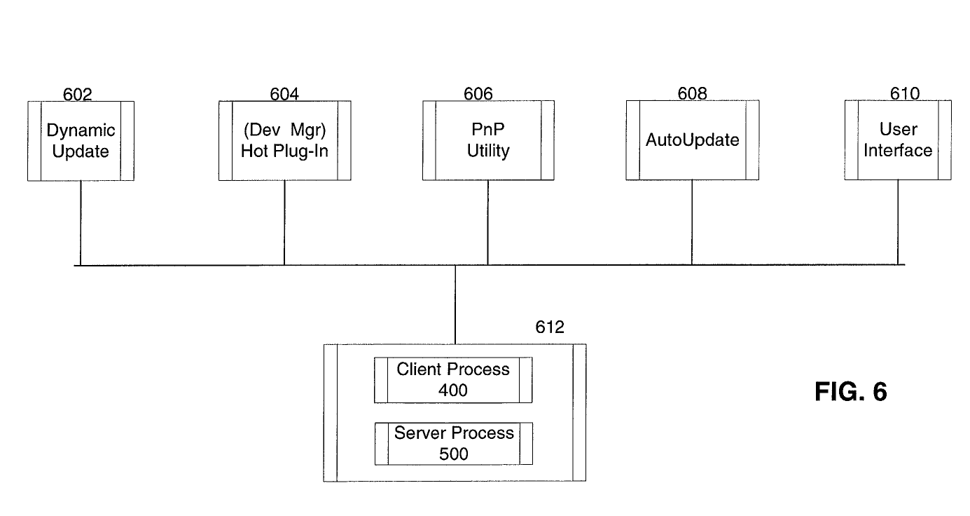

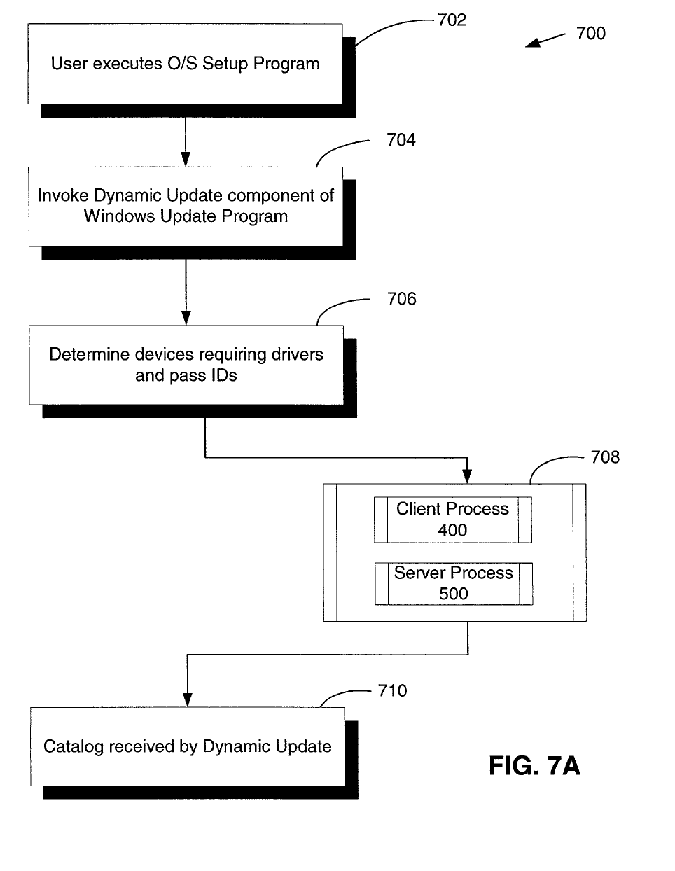

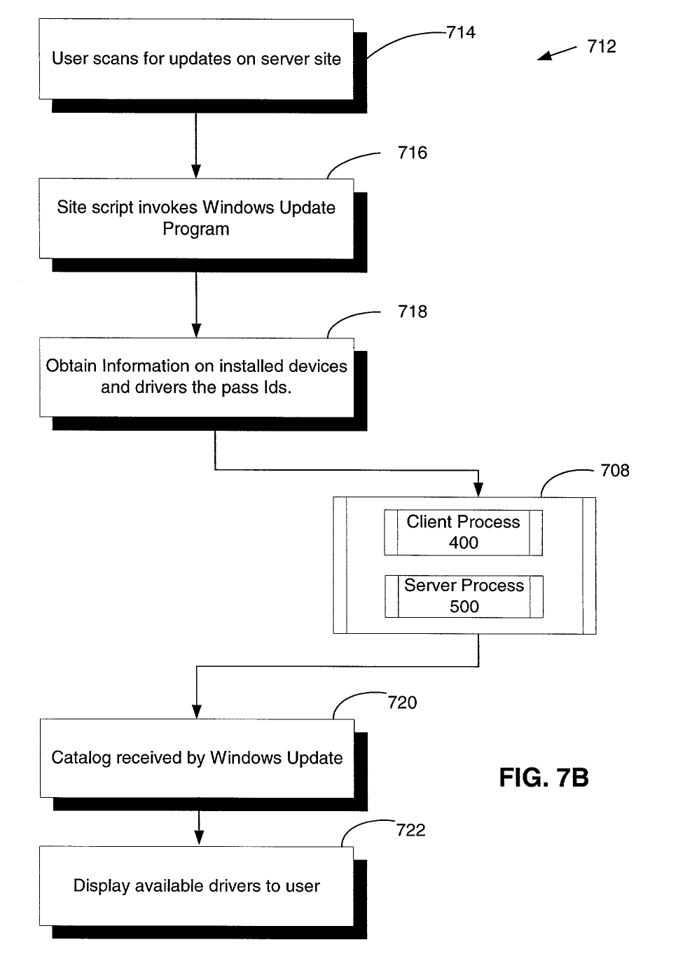

FIG. 6 is an illustration of some parent client system utilities/applications in the WINDOWS operating system environment that utilize the system and method of the present invention for obtaining new or updated drivers. For each of the illustrated parent utilities/applications a brief discussion of a scenario for the particular interaction between the application and the present invention will be discussed with reference to FIGS. 7 through 10. Turning initially to FIG. 6, there is a Dynamic Update utility 602, which is utilized by a client system to locate the most recent versions of various drivers, libraries and other operating system related software components. Device Manger 604 is a utility that can be used by a user or other functions on a client system, such as when there is a hot plug-in of a card. PnP utility 606, is a utility that enables the automated identification of devices that are installed in a client system. PnP utility 606, utilizes the present invention for locating drivers and updates to drivers for the newly installed device or hardware. AutoUpdate application 608, is a utility that will not only locate an improved or updated driver but will also install the driver, which it obtains by utilizing the present invention. User interface 610, represents the ability to have any customized application or program that will engage the user in the selection and decision to download or install any drivers located by the present invention. Each of the utilities or applications is able to interact with and utilize the client and server processes 612 of the present invention. Further, the described utilities may also be used in conjunction with one another.

Turning first to Dynamic Update 602, it provides a variety of components that perform functions including dynamic-update, which is illustrated by the flow diagram 700 of FIG. 7A and site driver check, which is illustrated by the flow diagram 710 of FIG. 7B.

Turning to FIG. 7A, dynamic-update is a component of the WINDOWS Update application that locates the most recent versions of system files including drivers, libraries etc. during an operating system installation process. In this illustrated scenario 700, a user executes the setup program for the operating system at step 702. The setup program enables the install and configuration of a client computing device. In the case of WINDOWS Operating System, the setup program initiates the dynamic-update component of the WINDOWS Update application, at step 704. As previously discussed dynamic-update is one of several utilities that is able to utilize the present invention. At step 706, dynamic-update investigates all of the hardware devices on the system and through interacting with the setup program determines which ones will need to have drivers located. Following this, the system and method of the present invention are invoked at step 708. In other words, the client process 400 of FIG. 4 and server process 500 of FIG. 5, are invoked and they receive the information pertaining to the hardware devices on the subject client device that need drivers.

As previously described, the outcome of invoking the present invention is a catalog of applicable drivers, which contains among other things, information on where applicable drivers are located. Accordingly, a catalog is returned to the dynamic-update component at step 710. The information in the catalog is then used to download cabinet (CAB) device package files which include information files (INFs) for the applicable devices and the system setup application program image is updated to utilize these download files.

Another scenario is illustrated in FIG. 7B for another WINDOWS Update component, namely site driver check, which is referenced as 712. Site driver check is a component that scans one or more web sites for driver updates, under user direction. At step 714, a user navigates to a WINDOWS Update site to scan for updates. A script on a server invokes the WINDOWS Update at step 716. WINDOWS Update obtains and passes information about all installed drivers including PnP identifications and driver versions at step 718. A catalog is returned to the WINDOWS Update program at step 720. The catalog that is returned to the site driver check by the processes of the present invention contains a list of drivers for devices that do not have currently installed drivers and a list of better drivers for devices that already have installed drivers. At step 722, the script of the WINDOWS Update site utilizes the catalog information to display the list of available drivers to the user who then selects the drivers that they wish to download and install.

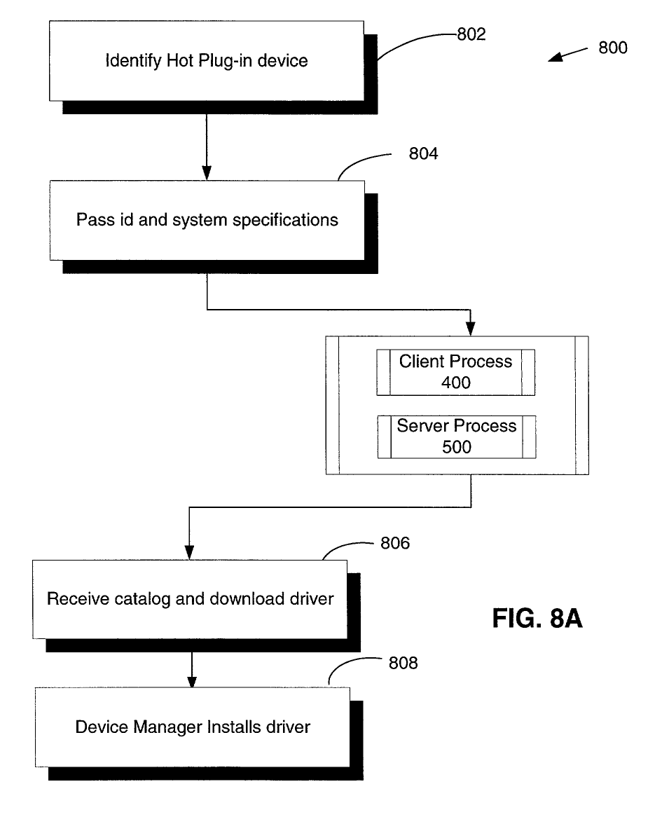

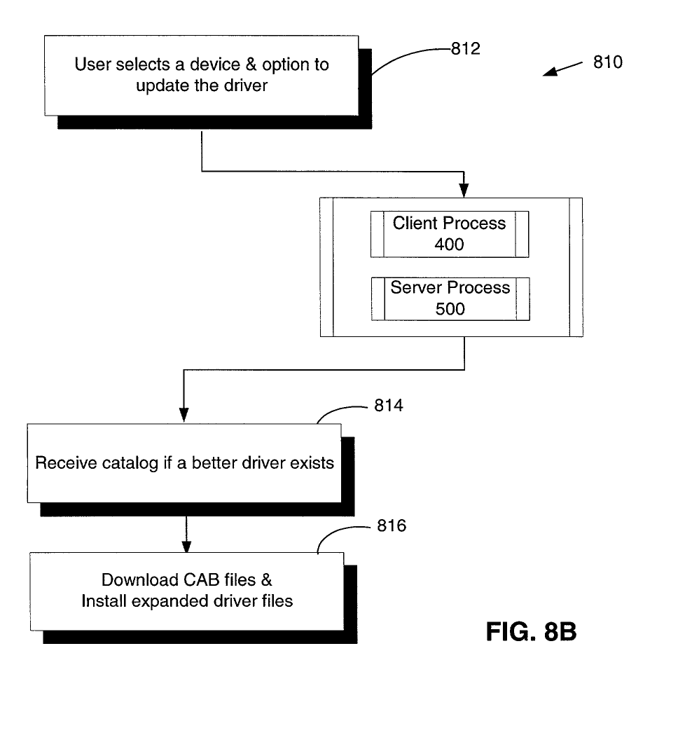

Yet another set of scenarios are illustrated in FIGS. 8A and 8B. These scenarios pertain to the Device Manager application of the WINDOWS operating system. FIG. 8A illustrates a scenario where a device is hot plugged-in to a client system. Hot plug-in is applicable to devices such as IEEE-1394 Firewire devices, PCMCIA cards, and USB devices, which are capable of being plugged into and recognized, by a client system while the system is on and operating. The component of the operating system that handles recognition is a part of Device Manager. As shown, an identification of the hot plug-in device is made at step 802. The identification process includes the gathering of other information including whether or not a driver is currently available on the client system along with any particulars on existing drivers. This is followed by invoking the process of present invention and passing the identified information at step 804. Whereupon, a catalog is returned in a similar manner to other cases where the present invention is utilized. However, in this instance because the driver is immediately needed to support the plugged in device, a download of the driver is initiated by the hot plug-in component using the catalog information, at step 806. Device Manager then installs the driver at step 808.

Another feature of device manager is the ability to electively update the driver of an already installed device. This scenario designated as 810 is illustrated in FIG. 8B. A user may select a device that is already installed and operational and elect to have the driver updated, as shown at step 812. The identification of the stated device in accordance with previously described methods is passed to the processes of present invention. As in all other cases, a catalog is returned to this parent application. At step 814, the information contained within the catalog is utilized to determine if a better driver than the installed driver does exist. In the event that a better driver does exist, the associated CAB files including information file (INF) supporting the device are downloaded to the client system, at step 816. As would be understood by one skilled in the art, the steps and procedures described herein for updating a driver can also be applied to obtain a driver that does not exist on the client system.

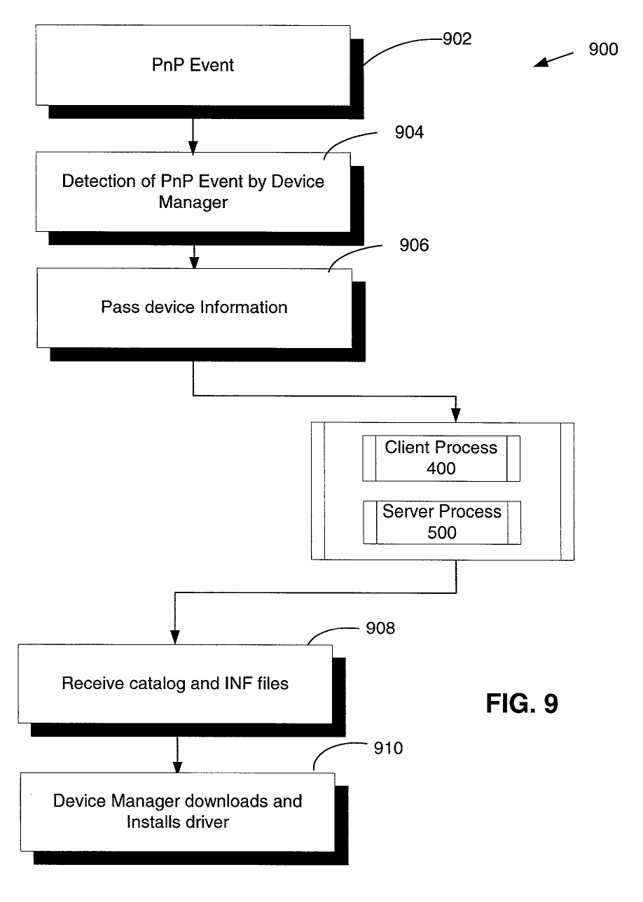

A further scenario of an application of the present invention can be found in the installation of PnP hardware devices in a client system. This scenario is illustrated in FIG. 9 and generally referenced as 900. At step 902, a PnP event is generated. Such an event occurs when a user installs a device into a PC or alternatively when a device is installed with power off and the user reboots the system. In either case, Device Manager application detects the PnP event at step 904, and obtains the relevant information regarding the device. As in other cases utilizing the present invention, the device node is passed to the system and method of the present invention at step 906. The method and system of the present invention then determines the device and compatible device information, which is passed to the server. A catalog is returned to the calling application at step 908. If the catalog contains information on the location of a driver, that driver is downloaded then the CAB files are expanded into a directory for use by Device Manager to install the driver at step 910.

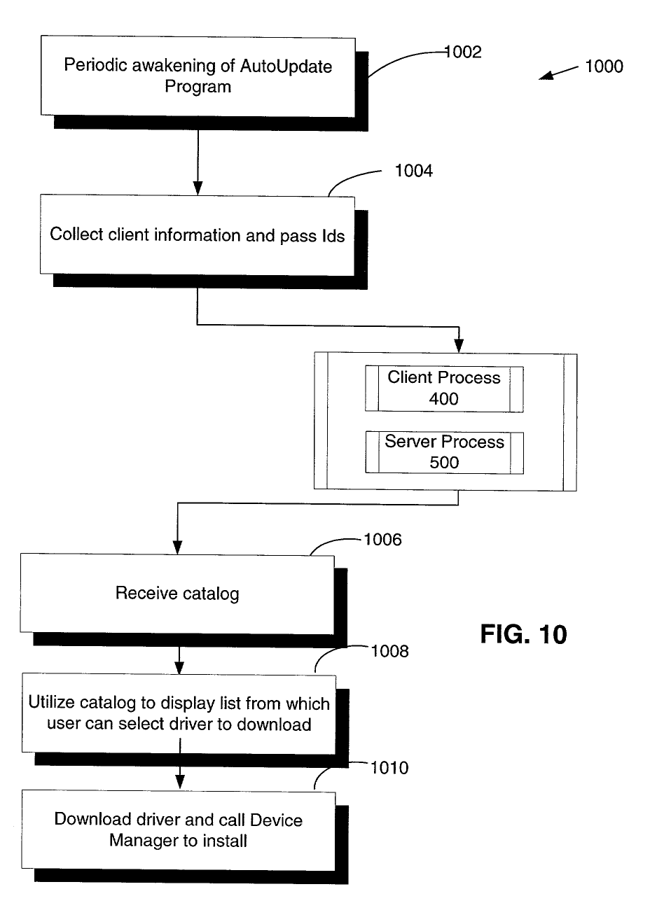

An even further scenario is illustrated in FIG. 10 and generally referenced as 1000. As earlier described Automatic Update service functions to periodically update information on a client system upon user acknowledgement. A user elects to have this service activated on their system. As a result, Automatic Update which is somewhat similar to WINDOWS Update, automatically displays a list of updates to the user. The list of updates are periodically displayed to the user rather than just content sites as in WINDOWS Update. Automatic Update can actually be a component of the WINDOWS Update application. At step 1002, Automatic Update is awakened by some event on the client system. Information about the client system is then collected. This information is passed to the system and method of the present invention at step 1004. A catalog is once again returned by the present invention to the automated updated utility, at step 1006. At step 1008, Automatic Update utilizes the catalog information to provide a user with a list of drivers from which the user may then select the drivers that the user wishes to install. For any drivers that are selected by the user, a download is performed and Device Manager performs the installation at step 1010.

Yet another scenario is the User Interface service 610 of FIG. 6. As earlier described, User Interface service represents the ability to have any customized application or program engage a user in the selection and decision to download or install any drivers. An example of such a service is a Graphical User Interface (GUI) utility program that enables a user to select a particular driver file to be updated. Such a utility would use the system and method of the present invention to provide information about the client system to a server that could then match and identify and appropriate update driver.

The system and method of the present invention is highly scalable and flexible as indicated by its various implementations. As discussed, the present invention provides several advantages. Among these advantages is the fact that no static catalogs are ever kept on any server, instead catalogs are generated when requested and on the basis of the client's hardware specifications. Another advantage is that indices of drivers on a server can be rebuilt and propagated quickly and efficiently thus drastically reducing the time that it takes to publish new content. Yet another advantage is that changes in detection algorithms can be implemented on the server without having to update the client software. An even further advantage is that the utilized methodology such as XML/SOAP based transactions, are not processor architecture dependent and can more easily be deployed on a variety of client systems. Further still, the present invention is extremely scalable with regards to the number and type of drivers that it can support. This is because of the reduction in redundant catalog information, which incidentally also means a smaller footprint on the server. Even further, the present invention enables independence between drivers unlike the hash bucket method. As such, individual drivers can be added or removed by simply updating the indices rather than building an entire site.

Implementations of the present invention is the seamless aggregation of drivers on an online service, third party servers, driver vendor servers or operating system vendor servers. So for instance, a corporate user would be able to host a set of proprietary drivers on their servers thus acting as a filter to suit their business needs, while still being able to have corporate client systems take advantage of external vendor drivers.

As would be understood by those skilled in the art, functions discussed as being performed on the client side or server side could be performed on any one or more computing devices, in a variety of combinations and configurations, and such variations are contemplated and within the scope of the present invention.

The present invention has been described in relation to particular embodiments which are intended in all respects to be illustrative rather than restrictive. Alternative embodiments will become apparent to those skilled in the art to which the present invention pertains without departing from its scope.

From the foregoing, it will be seen that this invention is one well adapted to attain all the ends and objects set forth above, together with other advantages which are obvious and inherent to the system and method. It will be understood that certain features and sub-combinations are of utility and may be employed without reference to other features and sub-combinations. This is contemplated and with the scope of the claims.

We claim:

1. A method for use in a networked computing environment for locating a device driver for a client computing device comprising:
obtaining information regarding installed devices on the client computing device; and
formatting said information so that said information is capable of transmission on the network to an update server and capable of interpretation by said update server.

2. The method as recited in claim 1 wherein said information is a specification of the operating environment of said client computing device.

3. The method as recited in claim 1, wherein the obtained information includes an identification of compatible devices.

4. The method as recited in claim 2, wherein the operating environment includes a description of the client computing device operating system.

5. The method as recited in claim 2, wherein the operating environment includes a description of the client computing device's hardware components.

6. The method as recited in claim 1 further comprising encapsulating said information into a protocol for transmission on the network.

7. The method as recited in claim 1 further comprising transmitting said information to said update server.

8. The method as recited in claim 7 further comprising receiving from said update server driver information, wherein said driver information contains an entry specifying a location of the device driver.

9. The method as recited in claim 8, wherein said location of the device driver is a content server on the network.

10. The method as recited in claim 8 wherein said driver information is a catalog.

11. The method as recited in claim 8, further comprising downloading the device driver from said location specified in said catalog.

12. The method as recited in claim 11, further comprising installing the device driver.

13. A computer system having a processor, a memory and an operating environment, the computer system operable to execute the method recited in claim 1.

14. A computer readable medium having computer executable instructions for performing a method for locating a device driver for a client computing device, the method comprising:
obtaining information regarding installed devices on the client computing device; and
formatting said information so that said information is capable of transmission on the network to an update server and capable of interpretation by said update server.

15. A method for use in a networked computing environment for locating a device driver for a client computing device comprising:
receiving on a server, device information relating to the client computing device;
matching said device information with a list of known drivers on said server; and
generating driver information capable of being transmitted to the client computing device;
wherein said driver information is capable of enabling said client computing device to download and install a device driver.

16. The method as recited in claim 15 wherein said device information includes an identification of one or more drivers for the installed devices on the client computing device;

17. The method as recited in claim 15 wherein said driver information is a catalog.

18. The method as recited in claim 15 further comprising transmitting said driver information to said client computing device, wherein said driver information contains information that will enable said client computing device to locate the device driver.

19. The method as recited in claim 15 wherein said device information is a specification of the client computing device.

20. The method as recited in claim 15 wherein said device information includes an identification of compatible devices.

21. The method as recited in claim 15 wherein said device information includes the operating environment of the client computing device.

22. The method as recited in claim 15, wherein said driver information contains URL's for the location of the device driver.

23. A computer system having a processor, a memory and an operating environment, the computer system operable to execute the method recited in claim 15.

24. A computer readable medium having computer executable instructions for performing a method for use in a networked computing environment for locating a device driver for a client computing device, the method comprising:
receiving on a server device information of the client computing device;
matching said device information with a list of known drivers on said server; and
generating driver information capable of being transmitted to the client computing device;
wherein said driver information is capable of enabling said client computing device to download and install a device driver.

25. A method for use in a networked computing environment for obtaining one or more drivers for a client computing device from one or more content servers comprising:
obtaining device information for a client computing device;
transmitting said device information from the client computing device to an update server;
receiving said device information on said update server;
matching said device information to an index on said update server, to identify driver information;
providing said driver information to the client computing device, wherein said driver information allows installion of one or more drivers on the client computing device.

26. The method as recited in claim 25 wherein install includes updating an existing driver.

27. The method as recited in claim 25 further comprising providing a new driver to the client computing device, wherein said new driver allows update of one or more drivers on the client computing device

28. The method as recited in claim 25 further comprising formatting said description in a data structure that is recognizable to an update server.

29. The method as recited in claim 25 further comprising matching device information compatible devices to said index on said update server, to identify driver information.

30. The method as recited in claim 25 wherein said driver information is usable to download the drivers or display information to enable a user to select drivers to be downloaded.

31. A computer system having a processor, a memory and an operating environment, the computer system operable to execute the method recited in claim 25.

32. A computer readable medium having computer executable instructions for performing a method for obtaining one or more drivers on a client computing device from one or more content servers, the method comprising:
obtaining device information for a client computing device;
transmitting said device information from the client computing device to said update server;
receiving said device information on said update server;
matching said device information to an index on said update server, to identify driver information;
providing said driver information to the client computing device, wherein said driver information allows install of one or more drivers on the client computing device.

33. A system for detecting and downloading drivers from a network comprising:
a programmed client device component that transmits device information on a client system to a server for processing; and
a server component that searches index tables based upon said device information received from said client system, to find compatible drivers and generates driver information to be returned to said client system;

34. A system as recited in claim 33, wherein said driver information provides the location of drivers on the network

35. A system as recited in claim 33 wherein said device information includes information on devices that are installed on said client system.

36. A system as recited in claim 33 wherein said device information includes information on drivers that are needed on said client system.

37. A system as recited in claim 33 wherein said server component performs an index search for all received compatible identifications from said client system, to find an initial match or a better match than any previously installed client drivers, and generates driver information to be returned to said client system.

38. The system as recited in claim 33 wherein said server component searches index tables for all devices received to find an initial match or a better match than any previously installed client drivers.
